(19) United States
(12) Patent Application Publication
(10) Pub. No.: US 2011/0301014 A1
(43) Pub. Date: Dec. 8, 2011

(54) APPARATUS AND METHOD FOR MANUFACTURING FLOAT GLASS

(76) Inventors: Woo-Hyun KIM, Dongducheon-si (KR); Sang-Oeb Na, Seoul (KR); Won-Jae Moon, Seoul (KR); Jeong-Deok Kim, Seoul (KR); Kil-Ho Kim, Suwon-si (KR); Heui-Joon Park, Paju-si (KR); Jin Han, Goyang-si (KR); Dong-Shin Shin, Bupyeong-gu (KR)

(21) Appl. No.: 13/151,335

(22) Filed: Jun. 2, 2011

(30) Foreign Application Priority Data
Jun. 3, 2010 (KR) 10-2010-0052485

(51) Int. Cl. C03B 18/16; C03B 18/18; C03C 3/00; C03B 18/02

(52) U.S. Cl. 501/11; 65/182.3; 65/32.5

(57) ABSTRACT

An apparatus for manufacturing a float glass includes a float bath in which a molten glass moves on a surface of a floatable molten metal to form a glass ribbon, a casing deformation preventing member for allowing an inert gas to flow around an end casing at an outlet of the float bath to prevent the end casing from deforming, a dross box disposed adjacent to a downstream end of the float bath and having lift-out rollers for drawing the glass ribbon, an introduction member for introducing an inert gas into the dross box, and a recycling path for supplying an inert gas, which discharges from the casing deformation preventing member, to the introducing member.

### CROSS-REFERENCE TO RELATED APPLICATION

This application claims priority under 35 U.S.C. §119(a) to Korean Patent Application No. 10-2010-0052485 filed at the Korean Intellectual Property Office on Jun. 3, 2010, the entire contents of which are incorporated herein by reference.

### BACKGROUND

1. Field

Exemplary embodiments relate to an apparatus and method for manufacturing a float glass, and more particularly, to an apparatus and method for manufacturing a float glass, which has an improved structure so that inert gas (e.g., nitrogen) used when manufacturing a float glass may be utilized more efficiently.

2. Description of the Related Art

Generally, a float glass manufacturing system continuously supplies molten glass onto a molten metal (e.g., a molten tin) stored in a float bath, forms a strip-shaped (or, ribbon-shaped) glass ribbon with consistent width and thickness while carrying the molten glass to float on the molten metal, and pulls the glass ribbon toward an annealing lehr adjacent to the outlet of the float bath to produce a glass plate.

Here, the molten metal may be for example a molten tin or a molten tin alloy and has a greater specific weight than the molten glass. The molten metal is received in a float chamber filled with reducing hydrogen (H₂) and/or nitrogen (N₂). In addition, the float bath receiving the molten metal is elongated in a length direction and includes special fireproof material. The molten glass moves from an upstream side of the float bath to a downstream side and is formed into a glass ribbon on the surface of the molten metal. Then, at a separating location (hereinafter, referred to as a “take-off point”) set at the downstream side of the float bath, the glass ribbon is lifted up away from the molten metal by lift-out rollers installed to a dross box, and the lifted glass ribbon is delivered through the dross box toward an annealing lehr for the next process.

However, since the molten metal in the float chamber has a high temperature (about 600 to 1,300° C.), molten metal, molten glass, N₂, H₂, tiny amount of O₂, H₂O, S₂ and so on are chemically reacted to generate impurities, which are generally called dross. In particular, since the region near the take-off point at the downstream side of the float bath has a lower temperature than the upstream side, the solubility of the molten metal may be deteriorated. For this reason, fine metal oxides for example impurities such as SnO₂ may be easily generated and stacked therearound.

The dross is attached to the lower surface of the molten glass and drawn from the float bath, when the ribbon-shaped molten glass is lifted up from the take-off point. Therefore, the dross may cause scratches or spots, which greatly damage the quality of a finally produced float glass.

Meanwhile, the gas containing a volatile tin in the float bath flows toward the downstream side of the float bath, namely toward the dross box, due to the positive pressure in the float bath. The gas flowing toward the dross box is condensed near the dross box and in a low-temperature region at the downstream side in the float bath to cause inferiorities on the surface of the moving glass and the surface of the molten tin. Dross is generally generated at 780° C. or below. In addition, though the inside of the float bath is kept at a positive pressure, an external air may be introduced to the downstream side of the float bath through the dross box. In this process, oxygen contained in the external air may be reacted with the volatile tin in the float bath at the relatively low-temperature region and then condensed, so that tin-based floating impurities are generated on the surface of the tin. In this case, while the ribbon-shaped glass is lifted up by the lift-out rollers and drawn out of the float bath, the tin-based floating impurity adhered to the surface of the molten tin is moved and drawn together with the bottom surface of the glass ribbon. This tin-based floating impurity may contaminate the dross box and the surface of the rollers used in the annealing process. In addition, in a case where the glass moves by the float bath or is annealed, the tin-based floating impurity may be a potential factor of an impurity forming at the bottom surface. Therefore, the tin-based floating impurity may deteriorate the safety of the annealing work and deteriorate the process stability and the quality of glass products.

In addition, in the conventional float glass manufacturing apparatus, the casing at the end of the float bath may be easily deformed due to the high temperature in the float bath. Therefore, the end casing of the float bath is protected by inert gas such as nitrogen which circulates through a path with a predetermined pattern formed at the outer side of the end casing of the float bath so that its deformation is prevented. However, the inert gas which circulates to cool the end casing of the float bath does not separately collect but discharges out, which may cause environmental pollutions.

### SUMMARY

The exemplary embodiments are designed to solve the problems of the prior art, and therefore the exemplary embodiments are directed to providing an apparatus and method for manufacturing a float glass with an improved structure in which, when an inert gas is supplied into a dross box to return the gas containing volatile tin and stored in a float bath toward an upstream side of the float bath by keeping the inside of the dross box to have a positive pressure, the inert gas used for preventing deformation of an end casing of the float bath is at least partially recycled to shorten a preheating time and to solve environmental pollutions.

In one aspect, the exemplary embodiment provides an apparatus for manufacturing a float glass, which includes a float bath in which a molten glass moves on a surface of a floatable molten metal to form a glass ribbon; a casing deformation preventing member for allowing an inert gas to flow around an end casing at an outlet of the float bath to prevent the end casing from deforming; a dross box disposed adjacent to a downstream end of the float bath and having lift-out rollers for drawing the glass ribbon; an introduction member for introducing an inert gas into the dross box; and a recycling path for supplying an inert gas, which discharges from the casing deformation preventing member, to the introducing member.

Preferably, the apparatus further includes a heating member installed at the recycling path.

Preferably, the inert gas includes argon, nitrogen or carbon dioxide.

Preferably, the heating member preheats the inert gas to about 600 to 850° C. In another aspect, the exemplary embodiment provides a method for manufacturing a float glass, which continuously supplies a molten glass onto a surface of a molten metal received in a float bath to form a glass ribbon and which pulls the glass ribbon from an outlet of the float bath and carries the glass ribbon to a cooling lehr, the method including: supplying at least a part of an inert gas, which is used for preventing an end casing of the float bath from deforming, into a dross box disposed between the float bath and the cooling lehr.

Preferably, the inert gas is preheated by the heating member.

Preferably, the inert gas includes argon, nitrogen or carbon dioxide.

Preferably, the inert gas is preheated to about 600 to 850° C.

The apparatus and method for manufacturing a float glass according to the exemplary embodiment may prevent environmental pollutions and improve thermal efficiency since insert gas for protecting an end casing of a float bath may be at least partially utilized when inert gas (e.g., argon, nitrogen, carbon dioxide, etc.) is supplied into a dross box.

### BRIEF DESCRIPTION OF THE DRAWINGS

Other objects and aspects of the present invention will become apparent from the following descriptions of the embodiments with reference to the accompanying drawings in which:

FIG. 1 is a plan view schematically showing an apparatus for manufacturing a float glass ribbon according to an exemplary embodiment;

FIG. 2 is a schematic view showing the apparatus of FIG. 1 in a length direction;

FIG. 3 is a sectional view schematically showing the apparatus for manufacturing a float glass ribbon according to the exemplary embodiment;

FIG. 4 is a schematic view showing an end casing of the float bath according to an exemplary embodiment; and

FIG. 5 is a cross-sectional view of FIG. 4.

### DESCRIPTION OF THE PREFERRED EMBODIMENT

Hereinafter, an annealing apparatus and method for a float glass ribbon according to exemplary embodiments will be described in detail with reference to the accompanying drawings.

Prior to the description, it should be understood that the terms used in the specification and the appended claims should not be construed as limited to general and dictionary meanings, but interpreted based on the meanings and concepts corresponding to technical aspects of the present invention on the basis of the principle that the inventor is allowed to define terms appropriately for the best explanation. Therefore, the description proposed herein is just a preferable example for the purpose of illustrations only, not intended to limit the scope of the invention, so it should be understood that other equivalents and modifications could be made thereto without departing from the spirit and scope of the invention.

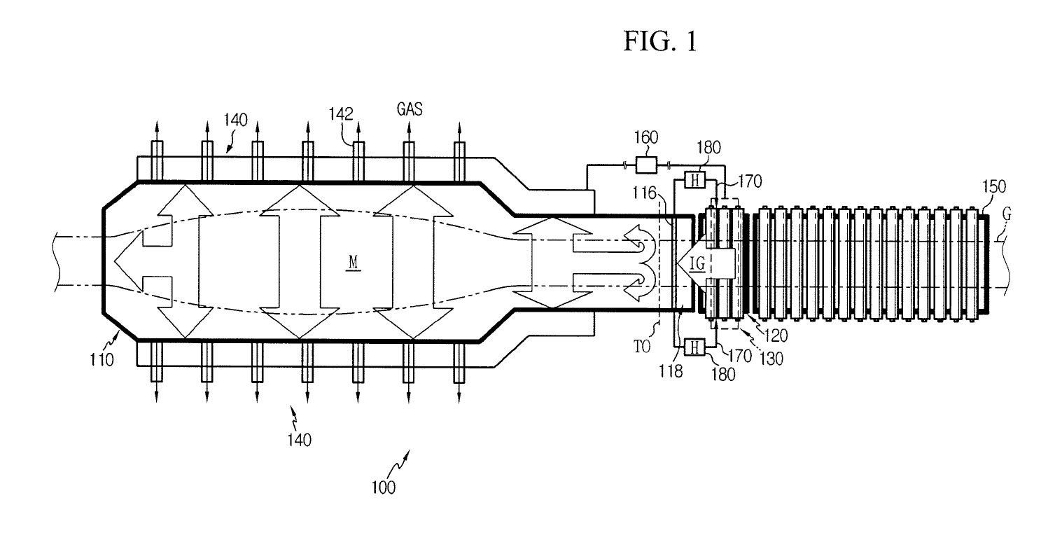

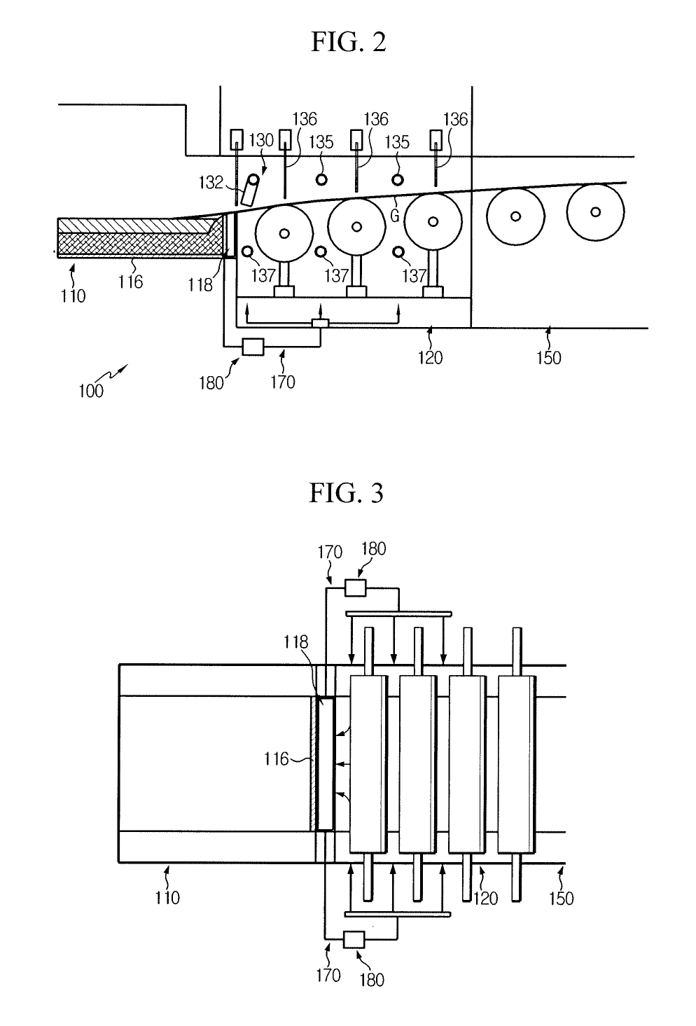

FIG. 1 is a plan view schematically showing an apparatus for manufacturing a float glass ribbon according to an exemplary embodiment, FIG. 2 is a schematic view showing the apparatus of FIG. 1 in a length direction, and FIG. 3 is a sectional view schematically showing the apparatus for manufacturing a float glass ribbon according to the exemplary embodiment.

Referring to FIGS. 1 to 3, an apparatus 100 for manufacturing a float glass ribbon according to this embodiment includes a float bath 110, a dross box 120, a reflow member 130, a gas discharging member 140, a recycling path 170, and a heating member 180.

The apparatus 100 for manufacturing a float glass according to this embodiment manufactures a float glass by a floating process, and the apparatus 100 includes a roof which covers the upper portion of the float bath 110 and a float chamber which is sealed and has an inlet and an outlet.

The float bath 110 stores molten metal M such as a molten tin and a molten tin alloy. The molten metal M is supplied from an upstream side (a left portion in the figures) of the float bath 110 and moves to a downstream side (a right portion in the figures). In this process, a glass ribbon is formed. In addition, the molten metal M floats from the upstream side of the float bath 110, which is kept at a relatively high temperature due to the temperature gradient in the float bath 110, to the downstream side and also floats from the center of the float bath 110 to both sides thereof. The molten glass G moves from the upstream side to the downstream side. After that, at a take-off point TO, the molten glass G is pulled toward the ceiling of a float chamber away from the bath surface of the molten metal M and is also drawn toward the dross box 120 for the next process.

The float bath 110 is composed of a mixed gas of nitrogen and oxygen. The mixed gas is kept at a pressure slightly higher than the atmospheric pressure. The molten metal M and the ribbon-shaped molten glass G are kept at about 800 to 1,300° C. by an electric heater (not shown). The molten glass G is a non-alkali glass, a soda lime glass, or the like. The principle or structure of generating a flow of the molten metal M in the float bath 110 and the process of putting, forming into a ribbon shape, moving or discharging the molten glass G are already well known in the art as a floating process, and they are not described in detail here.

The dross box 120 is disposed adjacent to the downstream end of the float bath 110. The dross box 120 has three lift-out rollers 122 arranged therein. The lift-out rollers 122 lift the molten glass G, which is supplied from the upstream side of the float bath 110 and moves onto the surface of the molten metal M toward the downstream side of the float bath 110, at a separating location set at the downstream side from the molten metal so that the molten glass G is supplied to a cooling lehr 150 disposed at the outlet of the dross box 120. The lift-out rollers 122 respectively rotate at a predetermined speed by a motor (not shown) and are spaced apart from each other at different horizontal locations so that the molten glass G may be easily drawn.

The reflow member 130 is used for returning the gas, which contains a volatile tin and flows from the downstream side of the float bath 110 to the dross box 120, to the upstream side of the float bath 110. The reflow member 130 is installed to the dross box 120.

The reflow member 130 includes a blowing means such as a motor and/blow fan and a gas supply unit 132 having a plurality of tubes and nozzles installed in the dross box 120 so that the inert gas is supplied to the upstream side of the float bath 110 through the outlet at the downstream side of the float bath 110.

On occasions, the reflow member 130 includes a tube system (not shown) which is installed on a slant from the dross box 120 to the float bath 110 and has sectors divided therein so that an operating region may change. Here, an inert gas IG such as argon, nitrogen and carbon dioxide is supplied through the outlet of the downstream side of the float bath 110 to the upstream side so that the gas in the float bath 110 which flows toward the downstream side of the float bath 110 may flow back. The pressure of the inert gas used for the reflow member 130 may be set relatively higher than the pressure at the downstream side of the float bath 110 (for example, about 1.0 atm to 2.0 atm). In addition, the inert gas IG is preferably preheated (e.g., to about 600 to 850° C.) before being supplied into the dross box 120. Moreover, the pressure Pd in the dross box 120 and the pressure Pf in the float bath 110 has a relation “Pd≧Pf”.

The gas supply unit 132 of the reflow member 130 includes an inclined supply tube which is inclined from the upper side of the dross box 120 to the lower side and extends toward the outlet of the float bath 110. The inclined supply tube may eject gas through its end portion. In addition, a plurality of gas injection holes (not shown) may also be formed in a part of the surface of the inclined supply tube around the end portion which is oriented to the outlet of the float bath 110.

The gas supply unit 132 includes first horizontal supply tubes 135 which are respectively installed between drapes 136 installed in the dross box 120 and disposed above the glass G and a plurality of second horizontal supply tubes 137 disposed below the glass G to be symmetric with the first horizontal supply tubes 135. Preferably, each of the first horizontal supply tubes 135 and the second horizontal supply tubes 137 has a gas injection hole (not shown) so that the gas is injected from the lower and upper sides toward the outlet of the float bath 110. In addition, the gas injection holes formed in the first horizontal supply tubes 135 and the second horizontal supply tubes 137 are preferably formed to correspond to the center portion, namely to the upper and lower surfaces of the glass G.

The gas supply unit 132 may be configured to directly eject gas from a sidewall of the dross box 120, and the pipes of the gas supply unit 132 may not be connected to each other, but instead be separated from each other even though the pipes extend from both sides to the center. The gas supply unit 132 of this embodiment preferably has the gas injection hole through which gas may be ejected from the dross box 120 to the outlet of the float bath 110.

The gas discharging member 140 discharges the gas, which flows toward the side of the float bath 110, to the outside. The gas discharging members 140 are respectively disposed at both sides of the float bath 110 to communicate the inside of the float bath 110. The gas discharging member 140 guides a mixed gas of oxygen and nitrogen, which contains a volatile tin or its mixture, to flow outwards at a high-temperature region of the float bath 110 so that impurities caused by tin groups do not move to the low-temperature region of the float bath 110. In this way, it is possible to prevent the surface of the glass or the surface of the molten tin from being defected by the condensed gas.

The gas discharging member 140 forms a passage through a side sealing (not shown) to ensure sealing between a lower structure and a steel casing which surrounds an upper refractory material of the float chamber or to ensure sealing between the lower structure and the upper refractory so that gas may pass through the passage. The gas moving through the passage flows out of the sidewall and flows on the upper portion.

The gas discharging member 140 may allow gas to naturally flow outwards by the positive pressure in the float bath 110. However, as described below, the gas discharging member 140 may be configured to forcibly discharge the gas in the float bath 110 by an air venturi, an ejector, a blow fan, and so on. This circulating vent system 142 is preferably installed at the wall of the upper structure or the side sealing box at each region. In other words, the gas discharging members 140 are preferably arranged densely along both sidewalls of the float bath 110, namely along the overall length of the float bath 110 from the upstream side to the downstream side.

In an exemplary embodiment, the apparatus 100 for manufacturing a float glass includes a circulation control member 160 for determining operating conditions of the gas discharging member 140 according to the temperature and/or amount of fluid which is supplied from the lower portion of the float bath 110 to the upper portion thereof by the reflow member 130. The circulation control member 160 monitors the temperature and/or flow rate of the inert gas which is supplied/moved from the reflow member 130 to the upstream side of the float bath 110 to adjust the flow rate according to the temperature and keeps the inside of the float bath 110 at a predetermined positive pressure to control the flow rate. Therefore, the circulation control member 160 may allow the gas to flow back in the float bath 110 with optimal conditions.

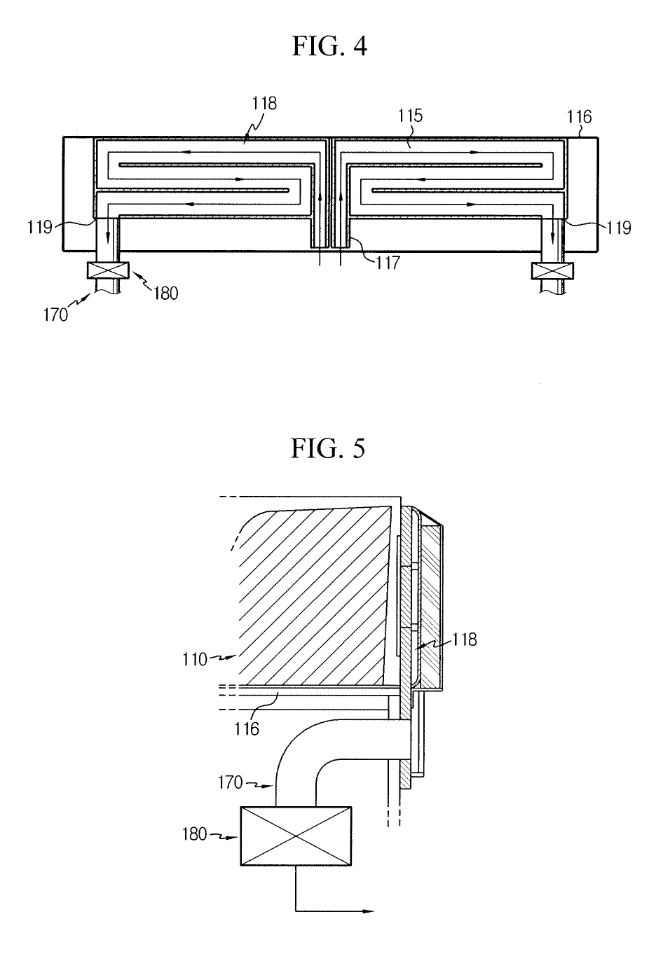

FIG. 4 is a schematic view showing an end casing of the float bath according to an exemplary embodiment, and FIG. 5 is a cross-sectional view of FIG. 4.

Referring to FIGS. 1 to 5, in this embodiment, a case deformation preventing jacket 118 is installed to the outer surface of an end casing 116 in order to prevent the end casing 116 of the float bath 110 from deforming. The jacket 118 has an input port 117 and an output port 119. In addition, the jacket 118 has a gas path 115 (see FIG. 4) for cooling the maximum surface area of the end casing 116. Inert gas such as nitrogen is supplied through the input port 117 from a gas supply source (not shown), and the inert gas is circulated through the gas path 115 and discharged through the output port 119.

The output port 119 is connected to the inlet of the reflow member 130 of the dross box 120 through the recycling path 170. A heating member 180 is installed at the recycling path 170. In other words, in this embodiment, the inert gas discharged through the output port 119 of the jacket 118 is preheated through the heating member 180 and then recycled into the dross box 120. However, it is also possible that the inert gas discharged from the jacket 118 is directly supplied into the dross box 120 without passing through the heating member 180 since the inert gas discharged from the jacket 118 has a certain temperature. Meanwhile, the reflow member 130 may receive inert gas from a separate inert gas supply source. However, the reflow member 130 may also be at least partially supplemented with the inert gas discharged from the jacket 118, and the reflow member 130 may entirely utilize the inert gas discharged from the jacket 118.

Hereinafter, operations of the apparatus for manufacturing a float glass according to an exemplary embodiment will be described.

The gas containing a volatile gas in the float bath 110, which flows to the downward side of the float bath 110, flows back by the inert gas supplied to the upstream side of the float bath 110 through the outlet at the downstream side by the reflow member 130 installed to the dross box 120. In addition, the gas flowing to both sides of the float bath 110 by the gas discharging member 140 discharges out of the float bath 110 so that an amount of gas flowing at the downstream side of the float bath to the dross box, and resultant impurities, decreases. Accordingly, the amount of impurities attached to and drawing along with the bottom of the glass is reduced. In this process, in order to prevent the end casing 116 of the float bath 110 from deforming, at least a part of the inert gas circulating through the gas path of the jacket 118 and then discharged through the output port 119 is supplied into the dross box 120 through the recycling path 170 which communicates the output port 119 and the inlet of the dross box 120. If necessary, the inert gas may be preheated by the heating member 180 to prevent the inert gas for the jacket 118 from discharging out, which may make better use of the inert gas.

Meanwhile, the present disclosure is not limited to the above embodiments, but suitable changes and modifications can be made thereto. For example, material, shape, dimension, number, locations and so on of the float bath, the molten metal, the molten glass, the spaced locations, the gas supply tube of the reflow member, the gas discharging member and so on can be selected as necessary within the scope of the invention, without being specially limited.

The present invention has been described in detail. However, it should be understood that the detailed description and specific examples, while indicating preferred embodiments of the invention, are given by way of illustration only, since various changes and modifications within the spirit and scope of the invention will become apparent to those skilled in the art from this detailed description.

What is claimed is:

1. An apparatus for manufacturing a float glass, comprising:
a float bath in which a molten glass moves on a surface of a floatable molten metal to form a glass ribbon;
a casing deformation preventing member for allowing an inert gas to flow around an end casing at an outlet of the float bath to prevent the end casing from deforming;
a dross box disposed adjacent to a downstream end of the float bath and having lift-out rollers for drawing the glass ribbon;
an introduction member for introducing an inert gas into the dross box; and
a recycling path for supplying an inert gas, which discharges from the casing deformation preventing member, to the introducing member.

2. The apparatus for manufacturing a float glass according to claim 1, further comprising a heating member installed at the recycling path.

3. The apparatus for manufacturing a float glass according to claim 1, wherein the inert gas includes argon, nitrogen or carbon dioxide.

4. The apparatus for manufacturing a float glass according to claim 2, wherein the heating member preheats the inert gas to about 600 to 850° C.

5. A method for manufacturing a float glass, which continuously supplies a molten glass onto a surface of a molten metal received in a float bath to form a glass ribbon and which pulls the glass ribbon from an outlet of the float bath and carries the glass ribbon to a cooling lehr, the method comprising:
supplying at least a part of inert gas, which is used for preventing an end casing of the float bath from deforming, into a dross box disposed between the float bath and the cooling lehr.

6. The method for manufacturing a float glass according to claim 5, wherein the inert gas is preheated by the heating member.

7. The method for manufacturing a float glass according to claim 5, wherein the inert gas includes argon, nitrogen or carbon dioxide.

8. The method for manufacturing a float glass according to claim 5, wherein the inert gas is preheated to about 600 to 850° C.

9. A float glass manufactured by the method according to claim 5.

10. A float glass manufactured by the method according to claim 6.

11. A float glass manufactured by the method according to claim 7.

12. A float glass manufactured by the method according to claim 8.
